(19) United States
(12) Patent Application Publication
(10) Pub. No.: US 2005/0130623 A1
(43) Pub. Date: Jun. 16, 2005

(54) Facilitating emergency calls made from a radio communication device

(76) Inventor: Mikko Narhi, Tampere (FI)

Correspondence Address: PERMAN & GREEN, 425 POST ROAD, FAIRFIELD, CT, 06824, US

(21) Appl. No.: 10/733,430

(22) Filed: Dec. 11, 2003

(51) Int. Cl. H04M 11/04

(52) U.S. Cl. 455/404.1; 455/521

(57) ABSTRACT

The invention relates to a method, device and computer program for facilitating emergency calls. In the method, a call dialed from a radio communication device is identified as being an emergency call. In response to the identified emergency call, one or more functions of the radio communication device not required for completion of the identified emergency call are automatically disabled.

### BACKGROUND OF THE INVENTION

1. Field of the Invention

The invention relates to radio communication devices. In particular, the invention relates to a novel and improved method, device and computer program for facilitating emergency calls.

2. Brief Description of Related Developments

Radio communication devices, such as mobile phones, have rapidly become commonly used throughout the world. Since mobile phones are nowadays operable in most places due to their wide coverage areas, and since they are typically carried around by the user, they are also used more and more for emergency calls. Emergency call refers to a call made to an emergency facility, such as for example an emergency service center, police or fire station. Typically the called emergency facility takes appropriate actions in response to a received emergency call.

Even though the near-instant availability of a typical mobile phone due to its mobility makes a mobile phone ideal for emergency calls, a typical mobile phone does have a drawback which might turn out to be critical in some cases. Mobile phones tend to be battery-operated, and these batteries tend to have quite limited durability. Thus there is a risk that the battery might run out while an emergency call is in progress.

Also, especially recent types of mobile phones typically have a wide variety of various applications implemented in them, and typically these various applications may be run simultaneously. From the point of view of completing emergency calls, this presents two problems. First, the more there are applications running simultaneously, the faster the battery is running out. Yet, the battery obviously should never run out during an emergency call. Second, the more there are applications running simultaneously, the more confusing the interface of the mobile phone typically becomes. For example, while the user is trying to make an emergency call, pop-up windows might be displayed notifying the user of incoming messages or calls. As it is probable that a person will be under stress in an emergency situation, the interface of the mobile phone should obviously not present any unnecessary distractions.

There have been some attempts in prior art to address some of the problems mentioned above. For example, it is previously known to store some energy to be used only for emergency calls. However, these approaches require battery-related hardware modifications, and therefore increase complexity and correspondingly costs. Further, they do not provide a solution to the above-mentioned problem of preventing any unnecessary distractions during an emergency call.

Further, EP0936794 discloses a radio communications device with emergency services. The device is able to receive an external signal, such as for example a signal-from an airbag, which triggers the device into an emergency mode in which only emergency calls can be. made. Again, this approach is far from ideal, as it requires an emergency mode to be triggered by an external signal. Further, EP0936794 fails to disclose turning off currently running unnecessary applications.

Thus there is an obvious need for a more sophisticated approach allowing protection of battery durability for an emergency call. In particular, there is a need for a solution allowing unnecessary applications to be turned off to save battery power when an emergency call is dialed. Furthermore, it is desirable that the applications are turned off automatically, i.e. that they require as little interaction from the user as possible.

### SUMMARY OF THE INVENTION

A first aspect of the invention is a method of facilitating emergency calls made from a radio communication device. The method comprises a step of identifying a call dialed from a radio communication device as being an emergency call. The method further comprises a step of automatically, i.e. without user interaction, disabling one or more functions of the radio communication device not required for completion of the identified emergency call in response to the identified emergency call.

In an embodiment of the invention the step of disabling functions is performed without notifying the user of the radio communication device.

In an embodiment of the invention the disabled functions comprise radio frequency related functions not required for completion of the emergency call.

In an embodiment of the invention the disabled functions comprise notifications unrelated to the emergency call.

A second aspect of the invention is a radio communication device. The radio communication device comprises an identifier configured to identify whether a dialed call is an emergency call. The radio communication device further comprises a controller, responsive to an identified emergency call, configured to automatically disable one or more functions not required for completing the identified emergency call.

A third aspect of the invention is a controller for facilitating emergency calls made from a radio communication device. The controller is responsive to an identified emergency call dialed from a radio communication device, and the controller is configured to automatically disable one or more functions of the radio communication device not required for completing the identified emergency call.

In an embodiment of the invention the controller is further configured to perform the automatic disabling of functions without notifying the user of the radio communication device.

A fourth aspect of the invention is a computer program comprising code adapted to perform the following steps when, executed on a data-processing device. A call dialed from a radio communication device is identified as being an emergency call. In response to the identified emergency call, one or more functions of the radio communication device not required for completion of the identified emergency call are automatically disabled.

In an embodiment of the invention the computer program is further adapted to perform the step of disabling functions without notifying the user of said radio communication device.

In an embodiment of the invention the computer program is stored on a computer-readable medium.

The invention allows facilitating emergency calls by automatically assuring that battery power is not wasted unnecessarily during an emergency call, and by automatically preventing unnecessary notifications from distracting the user. In particular, the invention allows unnecessary applications to be turned off in order to save battery power when an emergency call is dialed. Further, the invention allows the applications to be turned off automatically; i.e. no interactivity is required of the user. In the case of more complicated radio communication devices in which multiple applications may be running simultaneously, the invention simplifies making emergency calls significantly, since the multiple button presses normally required of the user to turn off the running applications are not necessary anymore. Further, the invention allows preventing unnecessary notifications, like for example various pop-up windows or notifications about incoming messages or calls, during an emergency call so that the user is not distracted in a distressing emergency situation.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a method according to an embodiment of the invention; and

FIG. 2 illustrates a radio communication device according to an embodiment of the invention.

### DETAILED DESCRIPTION OF THE PREFERRED EMBODIMENTS

Reference will now be made in detail to the embodiments of the invention, examples of which are illustrated in the accompanying drawings.

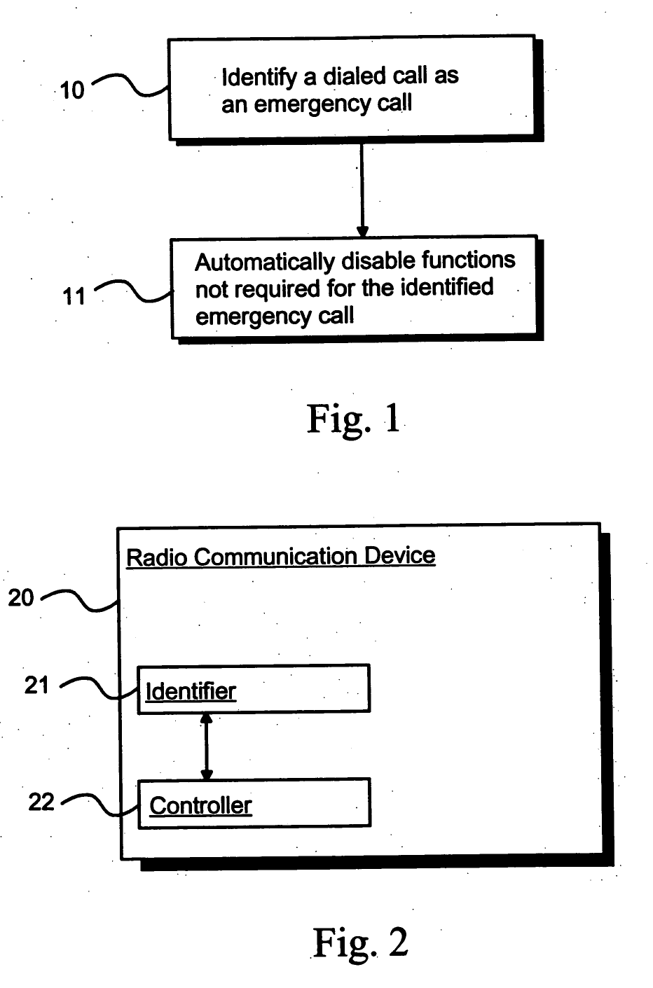

FIG. 1 is a flow chart illustrating an exemplary embodiment of the method of the present invention. In step 10 a call dialed from a radio communication device is identified as being an emergency call. In step 11 one or more functions of the radio communication device not required for completion of the identified emergency call are automatically disabled in response to the identified emergency call. Step 11 may be performed without notifying the user of the radio communication device, thus saving even further battery power and avoiding distracting the user unnecessarily in what may be a distressing emergency situation. In the context of the present invention, the term “disabling functions” is used to refer both to turning off current functions not required for completion of the identified emergency call, and to preventing prospective functions not required for completion of the identified emergency call from being turned on.

In an embodiment, the disabled functions comprise radio frequency related functions not required for completion of the emergency call. In an embodiment, the radio frequency related functions include, but are not limited to, incoming and outgoing voice calls, incoming and outgoing fax calls, incoming and outgoing short message transmissions, Bluetooth links in both incoming and outgoing directions, and Wireless Local Area Network (WLAN) links in both incoming and outgoing directions.

In an embodiment, the disabled functions comprise notifications unrelated to the emergency call. In an embodiment, these notifications include, but are not limited to, notifications about incoming messages and calls, and pop-up windows.

In an embodiment, the method of the present invention is implemented as a computer program comprising code adapted to perform the steps of the method when executed on a data-processing device. In an embodiment, the computer program is stored on a computer-readable medium, for example a magnetic or optical disk, or a memory card, such as a memory card removably attachable to a mobile terminal.

In an embodiment, the computer program of the present invention is implemented as part of existing software, for example as an interface in the operating system of a mobile terminal, such as prior art Symbian operating system. In an embodiment, the computer program is implemented as a software library.

FIG. 2 is a block diagram illustrating an exemplary embodiment of the radio communication device of the present invention. The term “radio communication device” refers to a portable communication device communicating over a radio interface. In an embodiment the radio communication device may be a mobile terminal, for example a mobile phone. The exemplary radio communication device 20 illustrated in FIG. 2 comprises an identifier 21 configured to identify whether a dialed call is an emergency call. The radio communication device 20 further comprises a controller 22, responsive to an identified emergency call, configured to automatically disable one or more functions not required for completing the identified emergency call.

The identifier 21 may be a prior art identifier implemented in hardware or software, or a combination thereof. Thus it is not discussed in further detail here.

The controller 22 may be further configured to perform the automatic disabling of functions without notifying the user of the radio communication device 20. In an embodiment, the controller 22 is implemented in hardware. In another embodiment, the controller 22 is implemented in software. The controller 22 may also be implemented as part of existing software, for example as an interface in the operating system of a mobile terminal, such as prior art Symbian operating system. In an embodiment, the controller 22 is implemented as a software library.

It is obvious to a person skilled in the art that with the advancement of technology, the basic idea of the invention may be implemented in various ways. The invention and its embodiments are thus not limited to the examples described above, instead they may vary within the scope of the claims.

1. A method of facilitating emergency calls made from a radio communication device, the method comprising:
identifying a call dialed from a radio communication device as being an emergency call, and
in response to said identified emergency call, automatically disabling one or more functions of said radio communication device not required for completion of said identified emergency call.

2. The method according to claim 1, wherein said step of disabling functions is performed without notifying the user of said radio communication device.

3. The method according to claim 1, wherein said disabled functions comprise radio frequency related functions not required for completion of said emergency call.

4. The method according to claim 1, wherein said disabled functions comprise notifications unrelated to said emergency call.

5. A radio communication device, comprising:
an identifier configured to identify whether a dialed call is an emergency call; and
a controller, responsive to an identified emergency call, configured to automatically disable one or more functions not required for completing said identified emergency call.

6. The radio communication device according to claim 5, wherein said controller is further configured to perform said automatic disabling of functions without notifying the user of said radio communication device.

7. The radio communication device according to claim 5, wherein said disabled functions comprise radio frequency related functions not required for completion of said emergency call.

8. The radio communication device according to claim 5, wherein said disabled functions comprise notifications unrelated to said emergency call.

9. A controller for facilitating emergency calls made from a radio communication device, wherein:
said controller is responsive to an identified emergency call dialed from a radio communication device,. and
said controller is configured to automatically disable one or more functions of said radio communication device not required for completing said identified emergency call.

10. The controller according to claim 9, wherein said controller is further configured to perform said automatic disabling of functions without notifying the user of said radio communication device.

11. A computer program comprising code adapted to perform the following steps when executed on a data-processing device:
identifying a call dialed from a radio communication device as being an emergency call, and
in response to said identified emergency call, automatically disabling one or more functions of said radio communication device not required for completion of said identified emergency call.

12. The computer program according to claim 11, further adapted to perform said step of disabling functions without notifying the user of said radio communication device.

13. The computer program according to claim 11, wherein said computer program is stored on a computer-readable medium.
